(19) United States
(12) Patent Application Publication
(10) Pub. No.: US 2018/0091851 A1
(43) Pub. Date: Mar. 29, 2018

(54) DISPLAY DEVICE AND SOURCE DEVICE CONTROLLING METHOD THEREOF

(71) Applicant: SAMSUNG ELECTRONICS CO., LTD., Suwon-si (KR)

(72) Inventor: Ji Hyun BAE, Hwaseong-si (KR)

(73) Assignee: SAMSUNG ELECTRONICS CO., LTD., Suwon-si (KR)

(21) Appl. No.: 15/713,128

(22) Filed: Sep. 22, 2017

(30) Foreign Application Priority Data
Sep. 26, 2016 (KR) 10-2016-0122948

(51) Int. Cl. H04N 21/443; H04N 21/422

(52) U.S. Cl. CPC H04N 21/4432; H04N 21/4436; H04N 21/42204

(57) ABSTRACT

A display device includes a first communication interface which is communicatively connected with a source device, a second communication interface that communicates with a remote control device, and a processor configured to identify whether a first signal is received from the source device when a power-on signal of the display device is received from the display device, to identify whether the first signal includes a specified image when the first signal is received from the source device, and to transmit a power-on request signal of the source device via the first communication interface or the second communication interface when the first signal is not received from the source device or when the first signal includes an image.

### CROSS-REFERENCE TO RELATED APPLICATION(S)

This application claims priority from Korean Patent Application No. 10-2016-0122948, filed on Sep. 26, 2016 in the Korean Intellectual Property Office, the disclosure of which is incorporated herein by reference in its entirety.

### TECHNICAL FIELD

Exemplary embodiments relate to a display device for receiving content from a source unit and displaying the content, and a source device controlling method thereof.

### BACKGROUND

As digital technology advances, electronic products are being developed and supplied with various types of functionalities. Together with multi-functionality of electronic products, there are many products, such as smartphones, which include diverse services which are implemented in a single device.

Additionally, the progress of communication technology increases services to be provided in an interlocking manner between electronic devices. In particular, an electronic device, such as a television (TV), may be connected with a content providing device, such as a smartphone, a set-top box, a game console, or the like, to provide users with a variety of content that is received from the content providing device.

A user is required to input a control instruction respectively to a display device and a source device in order to turn on/off power of the display device and the source device.

### SUMMARY

Aspects of the present disclosure are presented to address at least the above-mentioned problems and/or disadvantages and to provide at least the advantages described below. Accordingly, an aspect of the present disclosure is to provide a display device that is capable of turning on a display device and a source device at the same time via a one-time operation, and a source device controlling method of the display device.

In accordance with an aspect of one or more exemplary embodiments, a display device includes a first communication interface configured to be communicatively connected with a source device, a second communication interface that communicates with a remote control device, and a processor configured to identify whether a first signal is received from the source device when a power-on signal of the display device is received, to identify whether the first signal includes a predetermined image when the first signal is received from the source device, and to transmit a power-on request signal of the source device when the first signal is not received from the source device or when the first signal includes the predetermined image.

In accordance with another aspect of one or more exemplary embodiments, a source device controlling method of a display device includes receiving a power-on signal of the display device, identifying whether a first signal is received from a source device, identifying whether the first signal includes a predetermined image when the first signal is received from the source device, and transmitting a power-on request signal of the source device when the first signal is not received from the source device or when the first signal includes the predetermined image.

Other aspects, advantages, and salient features will become apparent to persons having ordinary skill in the art from the following detailed description, which, taken in conjunction with the annexed drawings, discloses various exemplary embodiments.

### BRIEF DESCRIPTION OF THE DRAWINGS

The above and other aspects, features, and advantages of certain exemplary embodiments will be more apparent from the following description taken in conjunction with the accompanying drawings, in which:

FIG. 1 is a diagram illustrating a display system, according to various exemplary embodiments;

FIG. 2 is a block diagram illustrating a configuration of a display device, according to an exemplary embodiment;

FIG. 3 is a timing diagram illustrating signals transmitted/received between a display device and a source device, according to various exemplary embodiments; and

FIG. 4 is a flow chart illustrating a power controlling method of a display device, according to various exemplary embodiments.

Throughout the drawings, it should be noted that like reference numbers are used to depict the same or similar elements, features, and structures.

### DETAILED DESCRIPTION

Hereinafter, various exemplary embodiments may be described with reference to accompanying drawings. Accordingly, those of ordinary skill in the art will recognize that modifications, equivalents, and/or alternatives with respect to the various exemplary embodiments described herein can be variously made without departing from the scope and spirit of the present inventive concept. With regard to description of drawings, similar elements may be marked by similar reference numerals.

In the present disclosure, the expressions “have”, “may have”, “include” and “comprise”, or “may include” and “may comprise” used herein indicate existence of corresponding features (e.g., elements such as numeric values, functions, operations, or components) but do not exclude a presence of additional features.

In the present disclosure, the expressions “A or B”, “at least one of A or/and B”, or “one or more of A or/and B”, and the like may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like as used in the present disclosure may be used to refer to various elements regardless of the order and/or the priority and to distinguish the relevant elements from other elements, but do not limit the elements. For example, “a first user device” and “a second user device” indicate different user devices regardless of the order or priority. For example, without departing the scope of the present disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element, or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used in this disclosure may be used as, for example, the expression “suitable for”, “having the capacity to”, “designed to”, “adapted to”, “made to”, or “capable of”. In particular, the term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor) which performs corresponding operations by executing one or more software programs which are stored in a memory device.

Terms used in the present disclosure are used to describe exemplary embodiments and are not intended to limit the scope of another exemplary embodiment. The terms of a singular form may include plural forms unless otherwise specified. All the terms used herein, which include technical or scientific terms, may have the same meaning that is generally understood by a person having ordinary skill in the art. It will be further understood that terms, which are defined in a dictionary and commonly used, should also be interpreted as being customary in the relevant related art and not in an idealized or overly formal unless expressly so defined in various exemplary embodiments of the present disclosure. In some cases, even if terms are terms which are defined in the present disclosure, they may not be interpreted to exclude exemplary embodiments of the present disclosure.

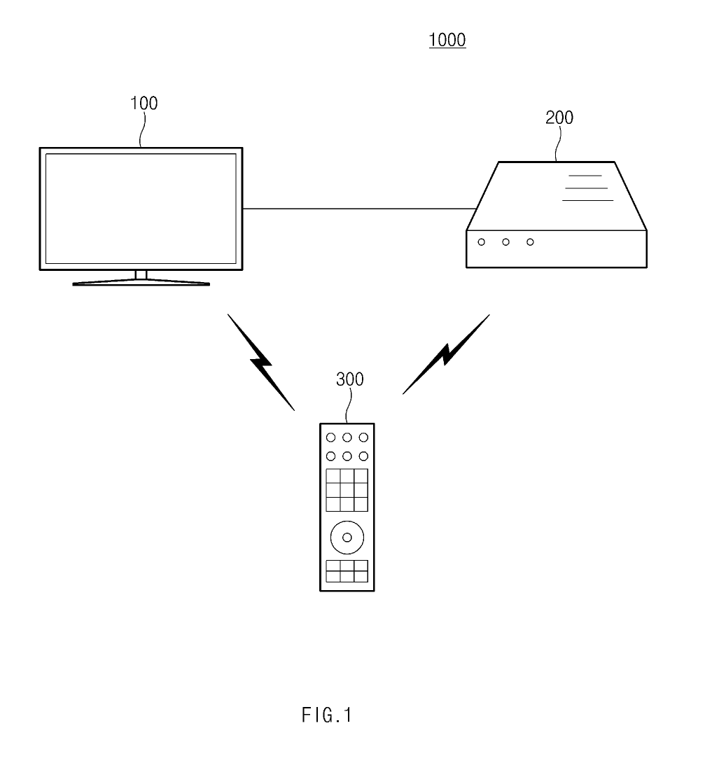

FIG. 1 is a diagram illustrating a display system, according to various exemplary embodiments.

Referring to FIG. 1, a display system 1000 may include a display device 100, a source device 200, and a remote control device 300.

According to an exemplary embodiment, the display device 100 may receive an image from an external device. For example, the display device 100 may be connected with the source device 200 via a first communication interface in order to receive content from the source device 200. The content may be, for example, content that includes image data such as movie, drama, news, game, or the like.

According to an exemplary embodiment, the display device 100 may communicate with the remote control device 300. For example, the display device 100 may transmit or receive a control signal to or from the remote control device 300 via a second communication interface.

According to an exemplary embodiment, the display device 100 may be implemented in any of various types which are capable of receiving content from an external device, such as a television (TV), a desk top computer, a notebook personal computer (PC), a smart phone, a tablet PC, a monitor, or the like, and displaying the content.

According to an exemplary embodiment, the source device 200 may transmit content, which is received from an external device or stored in an internal (or external) recording medium, to the display device 100. For example, the source device 200 may receive broadcasting content from a broadcasting station via a broadcasting network, or may receive web content from a web server via an Internet network. The source device 200 may play content stored in a recording medium and may transmit an image of the played content to the display device 100. The recording medium may include, for example, any of a Compact Disk (CD), a Digital Versatile Disk (DVD), a hard disk, a Blu-ray disk, a memory card, a universal serial bus (USB) memory, or the like.

According to an exemplary embodiment, the source device 200 may be implemented in any of various devices, such as a set-top box, a game console (e.g., Xbox™, PlayStation™, or the like), a smartphone, a tablet PC, and the like, which are capable of receiving or storing content and transmitting content to the display device 100.

According to an exemplary embodiment, the remote control device 300 may receive a user input and may transmit a control signal, which corresponds to the user input, to the display device 100 or the source device 200. The remote control device 300 may communicate with the display device 100 and the source device 200 via a wired or wireless interface. For example, the remote control device 300 may communicate via a wireless communication interface such as Bluetooth, near-field communication (NFC), or an infrared (IR) transmitter/receiver. According to an exemplary embodiment, the remote control device 300 may include at least one of a button, a touch panel, a motion recognition sensor, and/or a voice recognition sensor.

According to an exemplary embodiment, the remote control device 300 may transmit a control signal for controlling the display device 100 and for controlling a peripheral device (e.g., the source device 200) connected with the display device 100. According to an exemplary embodiment, the remote control device 300 may be a Multi-Brand Remote controller (MBR). For example, the remote control device 300 may store control signals of a plurality of the source devices 200. If identification information of the source device 200 which is selected as a current input source is received from the display device 100, the remote control device 300 may perform a connection operation with the source device 200 that corresponds to the received identification information, or may transmit a control signal to the source device 200 that corresponds to the received identification information.

According to an exemplary embodiment, the remote control device 300 may be a user terminal such as a smartphone, a tablet PC, or the like. For example, a user is able to control the display device 100 or the source device 200 by using an application installed in the remote control device 300. According to an exemplary embodiment, the remote control device 300 may be a home network device. For example, the remote control device 300 may be another device connected to a server or a home network to which the display device 100 and the source device 200 are connected.

According to an exemplary embodiment, in the display system 1000, the source device 200 may be powered on when the display device 100 is powered on. If a power-on signal is received from the remote control device 300 or an input module (e.g., a button, a touch panel, or the like), the display device 100 may determine (or identify) whether the source device 200 is powered on. If the source device 200 is power off (or in a standby state), the display device 100 may force the source device 200 to be powered on via a first communication interface or the remote control device 300.

According to an exemplary embodiment, the display device 100 may determine (or identify) whether the source device 200 is powered on based on whether a particular predetermined signal is received from the source device 200. Even in a state where the source device 200 is powered off, a case of transmitting a predetermined signal may occur. Accordingly, although the source device 200 is practically powered off, the display device 100 may determine that an image is being normally received in a state that the source device 200 is powered on. According to various exemplary embodiments, although a predetermined signal is received from the source device 200, the display device 100 may precisely determine whether the source device 200 is powered on or not by analyzing an image included in the predetermined signal.

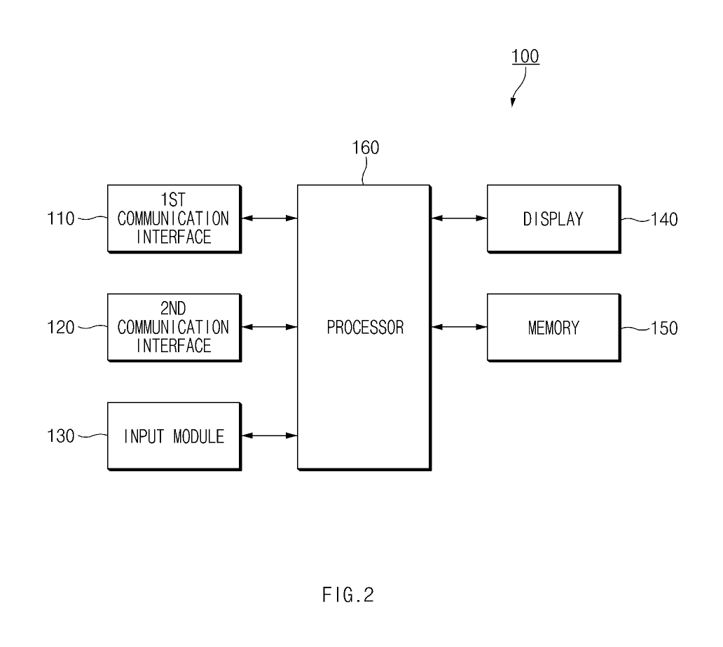

FIG. 2 is a block diagram illustrating a configuration of a display device, according to an exemplary embodiment.

Referring to FIG. 2, the display device 100 may include a first communication interface (or a first communication circuit) 110, a second communication interface (or a second communication circuit) 120, an input module (or an input interface) 130, a display 140, a memory 150, and a processor 160.

According to an exemplary embodiment, the first communication interface 110 may communicate with the source device 200. For example, the first communication interface 110 may be connected with the source device 200 in a wired or wireless manner in order to receive content from the source device 200. The first communication interface 110 may include, for example, at least one of wired interfaces, such as High Definition Multimedia Interface (HDMI) interface, Digital Video (Visual) Interface (DVI) interface, and Display Port (DP) interface, and wireless interfaces such as Bluetooth interface, Near Field Communication (NFC) interface, Wireless Fidelity (Wi-Fi) interface, and Infrared (IR) interface.

According to an exemplary embodiment, the second communication interface 120 may communicate with the remote control device 300. For example, the second communication interface 120 may be connected with the remote control device 300 in a wired or wireless manner in order to transmit or receive a control signal (e.g., power-on signal). The second communication interface 120 may include, for example, any of a Bluetooth interface, a Near Field Communication (NFC) interface, a Wireless Fidelity (Wi-Fi) interface, and an Infrared (IR) interface.

According to an exemplary embodiment, the input module 130 may receive a user input. According to an exemplary embodiment, the input module 130 may receive a user input which forces the display device 100 to be powered on. According to an exemplary embodiment, the input module 130 may include at least one of a touch sensor that is configured to sense a user's touch operation, a motion recognition sensor that is configured to recognize a user's motion, a voice recognition sensor that is configured to recognize a user's voice, and a button.

According to an exemplary embodiment, the display 140 may display an image received from a source device. The display 140 may include, for example, any of a Liquid Crystal Diode (LCD), a Light-Emitting Diode (LED) display, and/or an Organic LED (OLED) display.

According to an exemplary embodiment, the memory 150 may store a reference time. For example, the memory 150 may store a first reference time for determining whether a predetermined signal is received from the source device 200 after an initializing signal is transmitted to the source device 200. As another example, the memory 150 may store a second reference time for determining whether a predetermined signal is received from the source device 200 after a power-on request signal is transmitted. According to an exemplary embodiment, the reference time stored in the memory 150 may be updated based on a learning result from the source device 200.

According to an exemplary embodiment, the processor 160 may control overall operations of the display device 100. For example, the processor 160 may control power of the source device 200, according to various exemplary embodiments, by controlling each of the first communication interface 110, the second communication interface 120, the input module 130, the display 140, and the memory 150. According to an exemplary embodiment, the display device 100 may include at least one processor 160. For example, the display device 100 may include a plurality of processors 160, each of which is configured to perform at least one function. According to an exemplary embodiment, the processor 140 may be implemented with a System-on-Chip (SoC) including a Central Processing Unit (CPU), a Graphic Processing Unit (GPU), a memory, or the like.

According to an exemplary embodiment, the processor 160 may receive a power-on signal of the display device 100. For example, the processor 160 may receive a power-on signal from the remote control device 300 via the second communication interface 120. As another example, the processor 160 may receive a power-on signal from the input module 130. According to an exemplary embodiment, if a power-on signal of the display device 100 is received, the processor 160 may cause the display device 100 to be powered on.

According to an exemplary embodiment, if a power-on signal of the display device 100 is received, the processor 160 may determine whether a predetermined signal is received from the source device 200. The predetermined signal may be, for example, a signal that includes image data. For example, in the case that the display device 100 and the source device 200 are connected to each other via a HDMI interface or a DVI interface, the predetermined signal may be a Transition Minimized Differential Signaling (TMDS) signal (e.g., TMDS clock signal and/or TMDS data signal).

According to an exemplary embodiment, if a power-on signal is received, the processor 160 may transmit an initializing signal. The initializing signal may be, for example, a Hot Plug Detect (HPD) signal. According to an exemplary embodiment, the processor 160 may determine whether a predetermined signal is received from the source device 200 before the first reference time elapses after the initializing signal is transmitted.

According to an exemplary embodiment, if a specified signal is not received in the first reference time after the initializing signal is transmitted, the processor 160 may determine that the source device 200 is powered off and then may transmit a power-on request signal of the source device 200. For example, in the case that the display device 100 and the source device 200 are connected each other via a HDMI interface, the processor 160 may use a HDMI Consumer Electronics Control (HDMI CEC) function to transmit a power-on request signal (e.g., control signal that causes the source device 200 to be powered on) of the source device 200. As another example, the processor 160 may transmit a power-on request signal (e.g., a control signal turning on power of the source device 200, or a control signal instructing transmission of the control signal for turning on power of the source device 200 to the source device 200) of the source device 200 to the remote control device 300 via the second communication interface 120. According to an exemplary embodiment, the remote control device 300 may transmit a power-on request signal to the source device 200 in response to a power-on request of the display device 100. According to an exemplary embodiment, the processor 160 may transmit a power-on request signal that includes identification information that relates to the source device 200 which is selected as a current input source to the remote control device 300. According to an exemplary embodiment, the remote control device 300 may recognize identification information included in a power-on request signal, and may transmit the power-on request signal to the source device 200 that corresponds to the identification information. As another example, the remote control device 300 may transmit a power-on request signal of the source device 200 that corresponds to identification information.

According to an exemplary embodiment, if a predetermined signal is received within the first reference time period after an initializing signal is transmitted, the processor 160 may determine whether the received signal includes a predetermined image (or whether the display 140 is displaying the predetermined image). For example, a case may occur in which the source device 200 transmits a specified signal even in a power-off state. A signal transmitted when the source device 200 is powered off may not include a normal image, for example, may include a full-black image, or may not include image data. Accordingly, the processor 160 may determine whether a signal received from the source device 200 includes a full-black image or does not include image data.

According to an exemplary embodiment, the processor 160 may monitor a brightness value of an image included in a received signal. According to an exemplary embodiment, if a brightness value is smaller than a reference value for a predetermined amount of time (e.g., 3, 5, or 10 seconds), the processor 160 may determine that a received signal includes a predetermined image. For example, the processor 160 may monitor a value of Y component which represents a brightness value in an YCbCr (or YPbPr) color format. The reference value may be determined based on black color, or otherwise may be determined in consideration of any of a signal detecting error, a signal detecting position, and/or characteristics of the display device 100. If a signal received from the source device 200 includes a full black image or does not include image data, a value of Y component may be smaller than the reference value.

According to an exemplary embodiment, the processor 160 may capture an image included in a received signal and identify pixel values (or subpixel values) of pixels included in the captured image. According to an exemplary embodiment, if pixel values of pixels are smaller than a reference value, the processor 160 may determine that a received signal includes a specified image. The reference value may be determined, for example, based on black color, or may make a determination in consideration of any of a color format, characteristics of the display device 100, an image capturing position, or an image capturing position error. For example, if a color format of a captured image is the RGB color format, the processor 160 may determine whether values of Red, Green, and Blue components are respectively smaller than the reference value (e.g., 10). As another example, if a color format of a captured image is the YCbCr color format, the processor 160 may determine whether a value of Y is smaller than the reference value (e.g., 10). If a signal received from the source device 200 includes a full black image or does not include image data, pixel values of the captured image may be smaller than the reference value.

According to an exemplary embodiment, when capturing the image included in the received signal, the processor 160 may capture the image in units of frame. For example, the processor 160 may capture image data included in one image frame, and identify pixel values included in the captured image data. According to another exemplary embodiment, the processor 160 may capture only a part of a frame when capturing an image included in a received signal. For example, the processor 160 may capture a part of image data (e.g., a half of an image frame) included in one image frame, and identify pixels values included in the captured image data.

According to an exemplary embodiment, the processor 160 may capture an image, which is included in a received signal, during a specified time period (e.g., each of ⅓ or ⅕ seconds). According to an exemplary embodiment, if pixel values of a plurality of images captured for a specified amount of time (e.g., 3 or 5 seconds) are smaller than a reference value, a predetermined signal may be determined as including a specified image.

According to an exemplary embodiment, the processor 160 may monitor a driving signal (e.g., display panel driving signal or backlight driving signal) of the display 140. According to an exemplary embodiment, the display 140 may include a display panel and a panel driving module (e.g., Display Diver IC; DDI). A display driving module may transfer a driving signal, which corresponds to pixel values of pixels included in an image frame, to the display panel. According to an exemplary embodiment, the processor 160 may monitor a driving signal of the display 140 and may determine that a received signal includes a specified image if a level of the driving signal of the display 140 is equal to or smaller than a reference value. For example, if all pixels of a display panel are turned off for a predetermined amount of time, or if all backlights of an LCD are turned off for a predetermined amount of time, the processor 160 may determine that a received signal includes a specified image.

According to an exemplary embodiment, the processor 160 may determine whether a received signal includes a specified image by using a plurality of methods from among the aforementioned methods. According to an exemplary embodiment, if it is determined by at least one of the plurality of methods that a particular signal includes a specified image, the processor 160 may transmit a power-on request signal of the source device 200. According to an exemplary embodiment, if it is determined by the plurality of methods that a particular signal includes a specified image, the processor 160 may transmit a power-on request signal of the source device 200.

According to an exemplary embodiment, if a received signal does include a specified image, the processor 160 may determine that the source device 200 is powered on. According to an exemplary embodiment, if a received signal includes a specified image, the processor 160 may determine that the source device 200 is powered off and may transmit a power-on request signal of the source device 200. According to an exemplary embodiment, the processor 160 may transmit a power-on request signal after a lapse of a first reference time after an initializing signal is transmitted. For example, the processor 160 may wait for transmission of a power-on request signal before a lapse of a first reference time after an initializing signal is transmitted even though it is determined that a received signal includes a specified image.

According to an exemplary embodiment, the processor 160 may determine that a particular signal is received from the source device 200 in a second reference time after a power-on request signal is transmitted. According to an exemplary embodiment, if a particular signal is not received in the second reference time after a power-on request signal is transmitted, the processor 160 may display a User Interface (UI), which is associated with a status of the source device 200, on the display 140. For example, the processor 160 may display a UI which informs that the source device 200 is powered off, on the display 140. As another example, the processor 160 may display a UI which requests check for a power cable of the source device 200 or check for a connection status of a wired communication cable, on the display 140.

According to an exemplary embodiment, if a particular signal is received in the second reference time after a power-on request signal is transmitted, the processor 160 may determine whether the received signal includes a specified image (or whether the specified image is displayed on the display 140). According to an exemplary embodiment, if a received signal does include a specified image, the processor 160 may determine that the source device 200 is powered on. According to an exemplary embodiment, if a received signal includes a specified image, the processor 160 may display a UI which is associated with a status of the source device 200, on the display 200.

According to an exemplary embodiment, the processor 160 may update (or reset) a reference time (e.g., first reference time or second reference time). According to an exemplary embodiment, if a predetermined signal is received in a first reference time after an initializing signal is transmitted, the processor 160 may update the first reference time based on an amount of time that elapses until the reception of the predetermined signal after the initializing signal is transmitted. For example, the processor 160 may update the first reference time by adding a predetermined supplementary amount of time to the amount of time that elapses until the specified signal is received after the initializing signal is transmitted. According to an exemplary embodiment, if a predetermined signal is received in a second reference time after a power-on request signal is transmitted, the processor 160 may update the second reference time based on an amount of time that elapses until the reception of the predetermined signal after the power-on request signal is transmitted. For example, the processor 160 may update the second reference time by adding a predetermined supplementary amount of time to the amount of time that elapses until the predetermined signal is received after the power-on request signal is transmitted. According to an exemplary embodiment, the processor 160 may update the first reference time or the second reference time when a predetermined signal does not include a specified image.

According to an exemplary embodiment, the first communication interface 110 may be connected with a plurality of source devices 200. For example, a first HDMI interface may be connected with a set-top box and a second HDMI interface may be connected with a game console. According to an exemplary embodiment, the processor 160 may determine whether the source device 200 which is selected as a current input source is powered on. For example, the processor 160 may determine whether an initializing signal is transmitted to the source device 200 selected as a current input source or whether a predetermined signal is received from the source device 200 selected as the current input source. According to an exemplary embodiment, the processor 160 may transmit a power-on request signal, which includes identification information that relates to the source device 200 selected as a current input source, to the remote control device 300. The remote control device 300 may identify the identification information included in the power-on request signal, and may transmit the power-on request signal to the source device 200 that corresponds to the identification information, or may transmit the power-on request signal of the source device 200 that corresponds to the identification information.

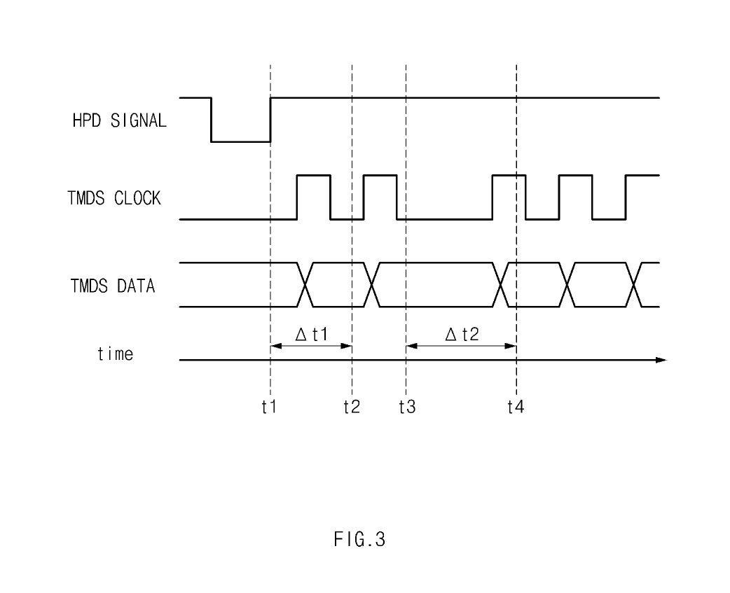

FIG. 3 is a timing diagram illustrating signals transmitted/received between a display device and a source device, according to various exemplary embodiments.

According to an exemplary embodiment, if a power-on request signal is received, the display device 100 may transmit an initializing signal (e.g., HPD signal) to the source device 200 at a first time t1. According to an exemplary embodiment, the display device 100 may transmit an HPD signal via a connector that connects to the first communication interface 110 with a wired cable. For example, in the case that the display device 100 and the source device 200 are connected to each other via an HDMI interface, the processor 160 may transmit the HPD signal through the #19 pin of the connector. The HPD signal may be, for example, a low active signal. As another example, the HPD signal may be a high active signal. According to an exemplary embodiment, if the HPD signal is received from the display device 100 in a power-on state, the source device 200 may identify that the display device 100 is powered on and then may transmit a predetermined signal to the display device 100.

According to an exemplary embodiment, the display device 100 may determine whether a predetermined signal (e.g., TMDS signal) is received in a first reference time Δt1 after the HPD signal is transmitted. According to an exemplary embodiment, if a predetermined signal (e.g., TMDS signal) is not received in the first reference time period Δt1 after the HPD signal is transmitted, the display device 100 may request a power-on request signal from the source device 200 at a second time t2. According to an exemplary embodiment, as illustrated in FIG. 3, if a predetermined signal (e.g., TMDS signal) is received in the first reference time Δt1 after the HPD signal is transmitted, the display device 100 may determine whether the received signal includes a specified image (or whether a specified image is displayed on the display 140). According to an exemplary embodiment, if it is determined that a received signal includes a specified image, the display device 100 may transmit a power-on request signal of the source device 200 at a third time t3.

According to an exemplary embodiment, if a predetermined signal (e.g., TMDS signal) is received in a second reference time period Δt2 after a power-on request signal of the source device 200 is transmitted at a third time t3, the display device 100 may determine whether the received signal includes a specified image (or whether the specified image is displayed on the display 140). According to an exemplary embodiment, if a received signal does not include a specified image, the display device 100 may determine that the source device 200 is powered on. According to an exemplary embodiment, if a predetermined signal (e.g., TMDS signal) is not received in the second reference time period Δt2 after a power-on request signal of the source device 200 is transmitted or if the received signal includes a specified image, the display device 100 may display a UI associated with a status of the source device 200.

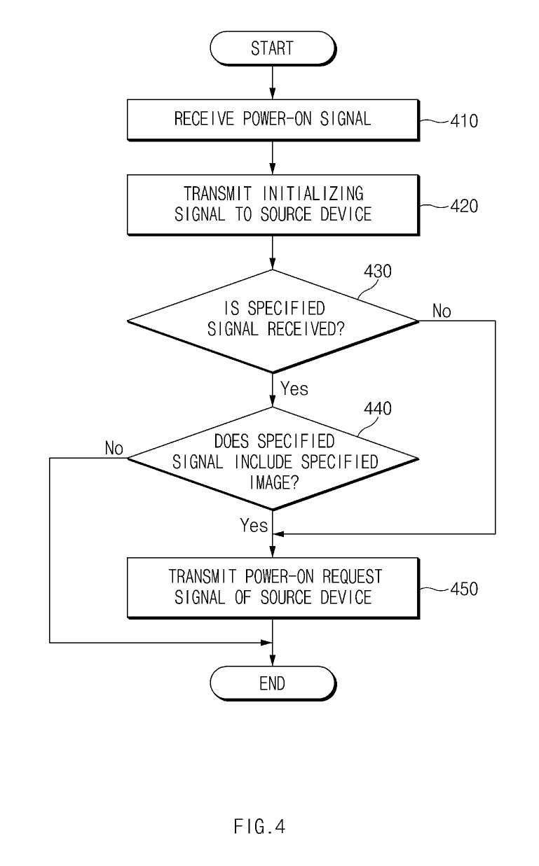

FIG. 4 is a flow chart illustrating a power controlling method of a display device, according to various exemplary embodiments.

The flowchart shown in FIG. 4 may include operations that the display device 100 processes. Therefore, even for matters omitted hereafter, the description about the display device with reference to FIGS. 1, 2, and 3 may be applicable to the flowchart shown in FIG. 4.

According to an exemplary embodiment, in operation 410, the display device 100 may receive a power-on signal. For example, the display device 100 may receive a power-on signal from the remote control device 300 for wireless communication, or may receive the power-on signal via the input module 130. According to an exemplary embodiment, if the power-on signal of the display device 100 is received, the processor 160 may cause the display device 100 to be powered on.

According to an exemplary embodiment, in operation 420, the display device 100 may transmit an initializing signal to the source device 200. The initializing signal may be, for example, a Hot Plug Detect (HPD) signal. According to an exemplary embodiment, in the case that the display device 100 is connected with a plurality of the source devices 200, an initializing signal may be transmitted to the source device 200 which is selected as a current input source.

According to an exemplary embodiment, in operation 430, the display device 100 may determine (or identify) whether a predetermined signal is received from the source device 200. According to an exemplary embodiment, the display device 100 may determine whether a predetermined signal is received from the source device 200 before the first reference time period elapses. According to an exemplary embodiment, in the case that the display device 100 is connected with a plurality of the source devices 200, the display device 100 may determine that a predetermined signal is received from the source device 200 which is selected as a current input source.

According to an exemplary embodiment, if a predetermined signal is not received from the source device 200 in the first reference time period, in operation 450, the display device 100 may transmit a power-on request signal of the source device 200. For example, the display device 100 may transmit a power-on request signal of the source device 200 to the remote control device 300 via the second communication interface 120.

According to an exemplary embodiment, when a signal is received from the source device 200 in the first reference time period, in operation 440, the display device 100 may determine (or identify) whether the received signal includes a specified image.

According to an exemplary embodiment, the display device 100 may monitor a brightness value of an image included in a received signal. According to an exemplary embodiment, if a brightness value of an image is smaller than a reference value for a predetermined amount of time, the display device 100 may determine that the received signal includes a specified image.

According to an exemplary embodiment, the display device 100 may capture an image included in a received signal and may identify pixel values (or subpixel values) of pixels included in the captured image. According to an exemplary embodiment, if the pixel values of the pixels are smaller than a reference value, the display device 100 may determine that the received signal includes a specified image. According to an exemplary embodiment, the display device 100 may capture an image, which is included in a received signal, in units of frame when capturing the image. According to an exemplary embodiment, if pixel values of a plurality of images captured for a predetermined amount of time are smaller than a reference value, the display device 100 may determine that the received signal includes a specified image.

According to an exemplary embodiment, the display device 100 may monitor a driving signal (e.g., a display panel driving signal or a backlight driving signal) of the display 140. According to an exemplary embodiment, if a level of the driving signal of the display is smaller than a reference value for a predetermined amount of time, the display device 100 may determine that a received signal includes a specified image.

According to an exemplary embodiment, if a received signal includes a specified image, in operation 450, the display device 100 may transmit a power-on request signal of the source device 200. According to an exemplary embodiment, the display device 100 may transmit a power-on request signal, which includes identification information that relates the source device 200 which is selected as a current input source, to the remote control device 300.

According to an exemplary embodiment, if a predetermined signal does not include a specified image, the display device 100 may update the first reference time based on an amount of time that elapses until the predetermined signal is received after an initializing signal is transmitted.

The term “module” as used in the present disclosure may include a unit implemented with hardware, software or firmware. For example, the term “module” may be interchangeably used with the terms “logic”, “logical block”, “component” and “circuit”. The “module” may be an integrated component or may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various exemplary embodiments may be, for example, implemented by instructions stored in computer-readable storage media in the form of a program module. The instruction, when executed by a processor, may cause the processor to perform a function corresponding to the instruction. A non-transitory computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), and an internal memory. Further, an instruction may include not only a code generated by a compiler but also a code that is executable by using an interpreter. A module or a program module according to various exemplary embodiments may include at least one of the above elements, or a part of the above elements may be omitted, or additional other elements may be further included.

Operations performed by a module, a program module, or other elements according to various exemplary embodiments may be executed sequentially, in parallel, repeatedly, or in a heuristic method. In addition, some operations may be executed in different sequences or may be omitted. Alternatively, other operations may be added.

According to various exemplary embodiments, it may be possible to enhance convenience for a user by turning on all power of a display device and a source device as a result of a one-time manipulation performed by the user.

According to various exemplary embodiments, it may be possible to turn on all power of a display device and a source device even in the case of transmitting a specified signal to the display device while the source device is powered off.

While the present disclosure has been shown and described with reference to various exemplary embodiments, it will be understood by persons having ordinary skill in the art that various changes in form and details may be made therein without departing from the spirit and scope of the present disclosure as defined by the appended claims and their equivalents.

What is claimed is:

1. A display device comprising:
a first communication interface configured to be communicatively connected with a source device;
a second communication interface configured to communicate with a remote control device; and
a processor configured to identify whether a first signal is received from the source device when a power-on signal of the display device is received, to identify whether the first signal includes a predetermined image when the first signal is received from the source device, and to transmit a power-on request signal of the source device when the first signal is not received from the source device or when the first signal includes the predetermined image.

2. The display device of claim 1, wherein the processor is further configured to monitor a brightness value of an image included in the first signal and to determine that the first signal includes the predetermined image when the brightness value is smaller than a reference value for a predetermined amount of time.

3. The display device of claim 1, wherein the processor is further configured to capture an image included in the first signal, to identify pixel values of pixels included in the captured image, and to determine that the first signal includes the predetermined image when the pixel values of the captured image are smaller than a reference value.

4. The display device of claim 1, wherein the processor is further configured to capture a plurality of images during a predetermined time period and to determine that the first signal includes the predetermined image when pixel values of at least one image from among the plurality of images are smaller than a reference value.

5. The display device of claim 1, further comprising:
a display,
wherein the processor is further configured to identify a driving signal of the display and to determine whether the first signal includes the predetermined image based on the driving signal of the display.

6. The display device of claim 1, wherein the processor is further configured to transmit an initializing signal to the source device when the power-on signal is received, and to identify whether the first signal is received within a reference time after the initializing signal is transmitted.

7. The display device of claim 6, wherein when the first signal is received within the reference time and the first signal does not include the predetermined image, the processor is further configured to update the reference time based on an amount of time that elapses until the first signal is received after the initializing signal is transmitted.

8. The display device of claim 1, wherein the first communication interface is further configured to be communicatively connected with a plurality of source devices, and
wherein the processor is further configured to identify whether the first signal is received from a first source device which is selected as a current input source from among the plurality of source devices.

9. The display device of claim 1, wherein the processor is further configured to transmit the power-on request signal, which includes identification information that relates to a first source device which is selected as a current input source from among a plurality of source devices, to the remote control device via the second communication interface.

10. The display device of claim 1, wherein the processor is further configured to transmit the power-on request signal of the source device to the source device via the first communication interface.

11. A source device controlling method of a display device, the method comprising:
receiving a power-on signal of the display device;
identifying whether a first signal is received from a source device;
identifying whether the first signal includes a predetermined image when the first signal is received from the source device; and
transmitting a power-on request signal of the source device when the first signal is not received from the source device or when the first signal includes the predetermined image.

12. The method of claim 11, wherein the identifying whether the first signal includes the predetermined image includes:
monitoring a brightness value of an image included in the first signal; and
determining that the first signal includes the predetermined image when the brightness value is smaller than a reference value for a predetermined amount of time.

13. The method of claim 11, wherein the identifying whether the first signal includes the predetermined image includes:
capturing an image included in the first signal;
identifying pixel values of pixels included in the captured image; and
determining that the first signal includes the predetermined image when the pixel values of the captured image are smaller than a reference value.

14. The method of claim 11, wherein the identifying whether the first signal includes the predetermined image includes:
capturing a plurality of images included in the first signal during a predetermined time period;
identifying pixel values of pixels included in each image from among the plurality of images; and
determining that the first signal includes the predetermined image when the pixel values of at least one image from among the plurality of images are smaller than a reference value.

15. The method of claim 11, wherein the identifying whether the first signal includes the predetermined image includes:
identifying a driving signal of the display device; and
determining whether the first signal includes the predetermined image based on the driving signal of the display device.

16. The method of claim 11, wherein the identifying whether the first signal is received includes:
transmitting an initializing signal to the source device when the power-on signal is received; and
identifying whether the first signal is received within a reference time after the initializing signal is transmitted.

17. The method of claim 16, further comprising:
updating the reference time based on an amount of time that elapses until the first signal is received after the initializing signal is transmitted when the first signal is received within the reference time and the first signal does not include the predetermined image.

18. The method of claim 11, wherein the identifying whether the first signal is received from the source device includes:
determining whether the first signal is received from a first source device which is selected as a current input source from among a plurality of source devices that are connected with the display device.

19. The method of claim 11, wherein the transmitting the power-on request signal of the source device includes:
transmitting the power-on request signal, which includes identification information that relates to a first source device which is selected as a current input source from among a plurality of source devices that are connected with the display device, to a remote control device.

20. A non-transitory computer-readable recording medium storing a program that implements a method, the method comprising:
receiving a power-on signal of a display device;
identifying whether a first signal is received from a source device;
identifying whether the first signal includes a predetermined image when the first signal is received from the source device; and
transmitting a power-on request signal of the source device when the first signal is not received from the source device or when the first signal includes the predetermined image.
